(19) United States
(12) Patent Application Publication
(10) Pub. No.: US 2008/0134086 A1
(43) Pub. Date: Jun. 5, 2008

(54) USER INTERFACE APPARATUS, METHOD, AND COMPUTER READABLE MEDIUM THEREOF

(75) Inventors: Yu-Chian Liao, Taipei City (TW); Chuang Hua Wang, Sindian City (TW)

Correspondence Address: PATTERSON, THUENTE, SKAAR & CHRISTENSEN, P.A., 4800 IDS CENTER, 80 SOUTH 8TH STREET, MINNEAPOLIS, MN, 55402-2100, US

(73) Assignee: INSTITUTE FOR INFORMATION INDUSTRY, Taipei (TW)

(21) Appl. No.: 11/682,136

(22) Filed: Mar. 5, 2007

(30) Foreign Application Priority Data
Dec. 1, 2006 (TW) 095144836

(51) Int. Cl. G06F 3/048

(52) U.S. Cl. 715/810; 715/848

(57) ABSTRACT

An apparatus, a method, an application program, and a computer readable medium thereof for processing and representing a user interface are provided. The user interface generates a plurality of options arranged in a two-dimensional menu, maps the options to a plurality of display units of a surface of a three-dimensional structure, and displays a portion of the display units. A user uses a controller to select the portion of the display units for display and to select one of the options. The user interface apparatus displays various categories and the options comprised in the categories on a screen at the same time. Consequently, the user is able to learn the structure of the two-dimensional menu, all categories, and all options at the first glance. The user can operate the user interface apparatus easily and enjoy the process of browsing and operating.

This application claims priority to Taiwan Patent Application No. 095144836 filed on Dec. 1, 2006, the disclosures of which are incorporated herein by reference in its entirety.

### CROSS-REFERENCES TO RELATED APPLICATIONS

Not applicable.

### BACKGROUND OF THE INVENTION

1. Field of the Invention

The present invention relates to a user interface apparatus and a method and a computer readable medium thereof for processing said user interface; specifically, it relates to a user interface apparatus, a method, and a computer readable medium thereof for displaying a two-dimensional menu on a three-dimensional structure on a screen.

2. Descriptions of the Related Art

With the rapid development of technologies, methods and apparatus for communication change from day to day. Among various communication apparatuses, mobile phones have a highest permeation rate and make people communicate easily. In early days, mobile phones support telephony functions only. However, in order to meet various requirements from people, current mobile phones provide more variety of functions, such as the simple telephony, a short message transmission, access of the Internet, music listening, photos taking, and videos recording.

With the growing number of the expanded functions, a user interface menu of the mobile phone becomes more complicated. Mobile phones in the early days provide few functions, so a menu is mainly switched one-dimensionally. With more and more functions provided by mobile phones, the one-dimensional menu switching is not enough operation for users. Consequently, two-dimensional operation interfaces appear, i.e. with up-down switching and left-right switching, to provide more options.

No matter the one-dimensional or the two-dimensional operation interfaces, the menu thereof can be expanded as a hierarchical tree structure. To be more specifically, the screen shows a plurality of main options first. Each of the main options comprises a plurality of sub-options, and each sub-option further comprises a plurality of child sub-options. When a user selects one of the main options, a user interface presenting in this manner displays only a menu structure of this selected main option (sub-options comprised in this main option). Sub-options comprised in other main options will not be displayed. If the user cannot determine which main option comprises the required sub-options, the try-and-error method is used to search the sub-options comprised in different main options. Not only time is wasted but also user emotion is affected. Furthermore, current hierarchical arranged menu only shows a single hierarchy and is unable to show a relationship between hierarchies. Therefore, user who is not familiar with the mobile phone system is easy perplexed so that the user loses his/her orientation in the complicated hierarchical structures, and is unable to find out the location of the required function option. This significantly degrades the usage efficiency of the user interface.

In summary, current menu arrangement of the user interface provides limited messages. The user cannot obtain the data relationship of other pages from a current page so that users who are unfamiliar with the system would take more time to find out the required option. Consequently, to provide a solution capable of displaying information of other hierarchies on the screen of the user interface for providing more information to the user and for enhancing the use efficiency of the user interface with a more directly perceived use method is still a necessary objective for the industry to endeavor.

### SUMMARY OF THE INVENTION

One objective of this invention is to provide a user interface apparatus comprising a processor, a mapping module, and a screen. The processor is used to generate a two-dimensional menu, which comprises a column menu and a row menu. The column menu comprises a plurality of sub-column options, and the row menu comprises a plurality of sub-row options. The mapping module is used to map a portion of the sub-column options and a portion of the sub-row options of the two-dimensional menu to a plurality of display units of a surface of a three-dimensional structure. The screen is used to display the display units corresponding to a portion of the surface.

Another objective of this invention is to provide a user interface processing method. The user interface processing method comprises the following steps: generating a two-dimensional menu, the two-dimensional menu comprising a column menu and a row menu, the column menu comprising a plurality of sub-column options, the row menu comprising a plurality of sub-row options; mapping a portion of the sub-column options and a portion of the sub-row options of the two-dimensional menu to a plurality of display units of a surface of a three-dimensional structure; and displaying the display units corresponding to a portion of the surface.

Yet a further objective of the invention is to provide a computer readable medium for storing an application program. The application program makes a user interface apparatus execute a user interface processing method. The user interface apparatus comprises a processor, a mapping module, and a screen. The user interface processing method comprises the following steps: making the processor generate a two-dimensional menu, the two-dimensional menu comprising a column menu and a row menu, the column menu comprising a plurality of sub-column options, the row menu comprising a plurality of sub-row options; making the mapping module map a portion of the sub-column options and a portion of the sub-row options of the two-dimensional menu to a plurality of display units of a surface of a three-dimensional structure; and making the screen display the display units corresponding to a portion of the surface.

The invention abandons current hierarchically arranged menus and makes the screen simultaneously show a plurality of categories and function options of the categories. In other words, the categories and options comprised in the categories are shown on the screen simultaneously. Consequently, a user can understand the whole structure of the two-dimensional menu, all categories, and all options at a first glance. With the aforementioned arrangements and steps, the time to search for functions can be reduced and the user would not lose his/her orientation during operating. Consequently, even the user uses the user interface apparatus for the first time, he or she can get familiar with the user interface apparatus quickly without much time and finds out the required option immediately. Therefore, the user can freely and cheerfully enjoy a product equipped with the user interface, such as a mobile phone. Thus, the product becomes more attractive and more acceptable and can be sold well.

The detailed technology and preferred embodiments implemented for the subject invention are described in the following paragraphs accompanying the appended drawings for people skilled in this field to well appreciate the features of the claimed invention.

### BRIEF DESCRIPTION OF THE DRAWINGS

FIG. 1A is a block diagram of a user interface apparatus of a first embodiment of the invention;

FIG. 1B is a schematic diagram of a mobile phone of a first embodiment of the invention;

FIG. 2A is a schematic diagram of a two-dimensional menu of a first embodiment of the invention;

FIG. 2B is a schematic diagram of a three-dimensional structure of a first embodiment of the invention;

FIG. 2C is a schematic diagram of a left-rotated three-dimensional structure of FIG. 2B of the invention; and

FIG. 2D is a schematic diagram of a down-rotated three-dimensional structure of FIG. 2B of the invention;

FIG. 3A is a schematic diagram of another three-dimensional structure;

FIG. 3B is a schematic diagram of another three-dimensional structure;

FIG. 3C is a schematic diagram of another three-dimensional structure;

FIG. 4 is a flow chart of a second embodiment of the invention; and

FIG. 5 is a flow chart of a third embodiment of the invention.

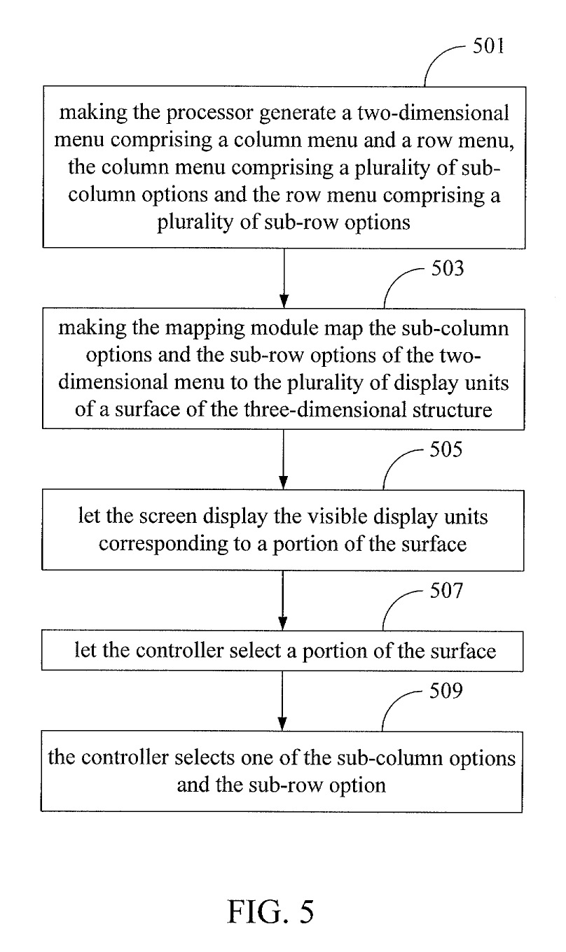

### DESCRIPTION OF THE PREFERRED EMBODIMENT

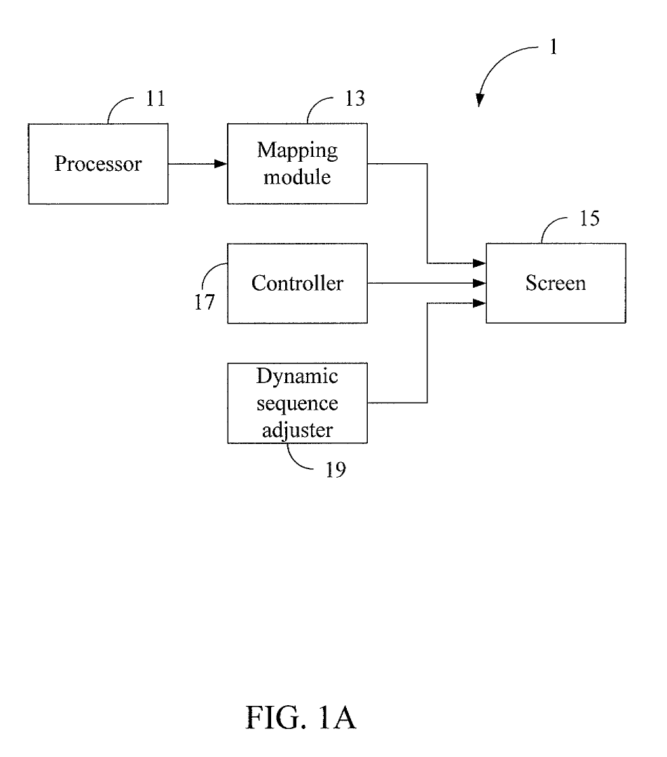

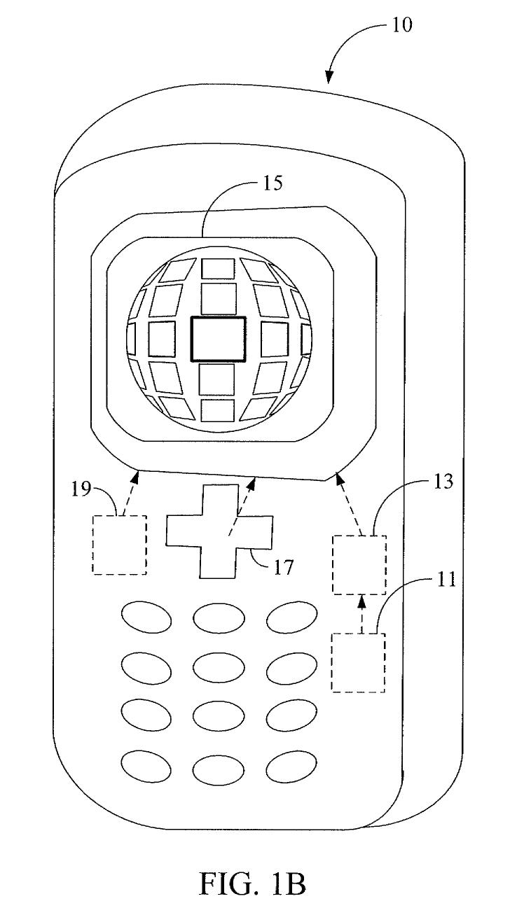

A first embodiment of the invention is a mobile phone 10 utilizing a user interface apparatus 1 as shown in FIG. 1A and FIG. 1B, which show the user interface apparatus 1 of this invention and the mobile phone 10 of this embodiment, respectively. The invention may be used in other apparatus equipped with a screen for displaying a menu, such as a personal digital assistant (PDA), a personal media player (PMP), and a computer, etc. More particularly, the invention is especially suited for handheld apparatuses for providing more usage information for the user. The user interface apparatus 1 comprises a processor 11, a mapping module 13, a screen 15, a controller 17, and a dynamic order adjuster 19.

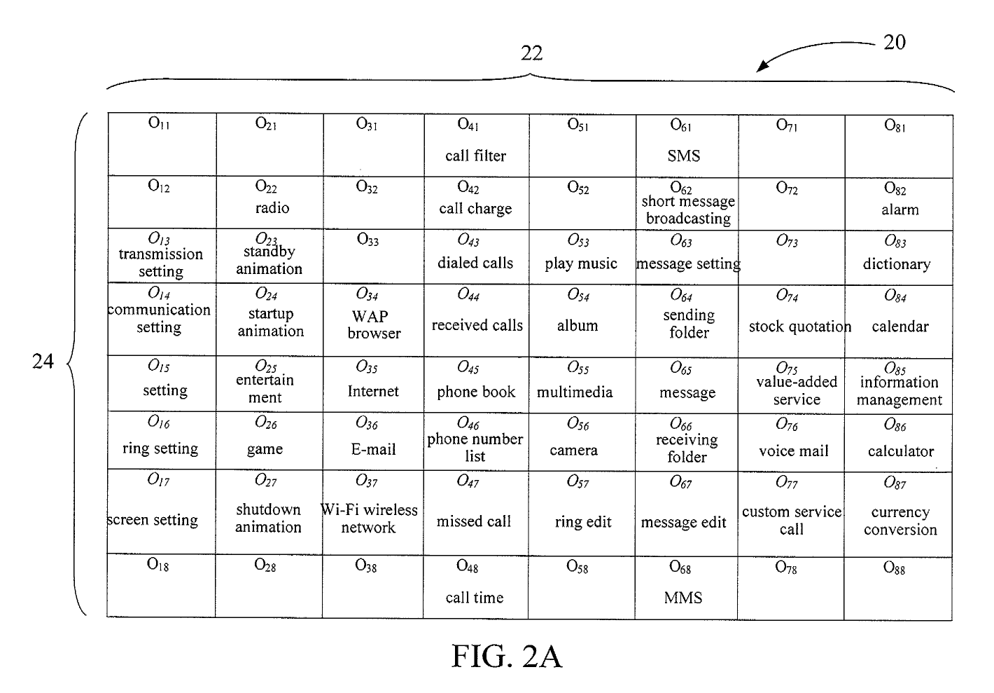

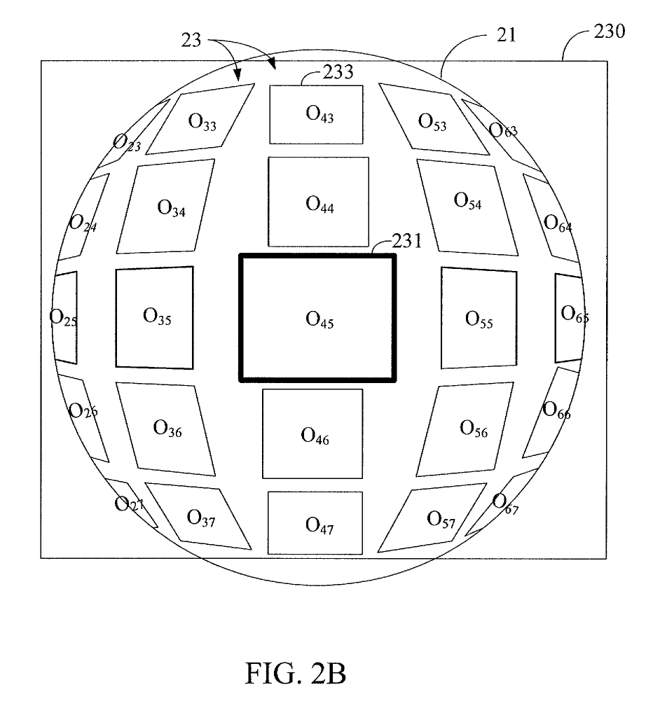

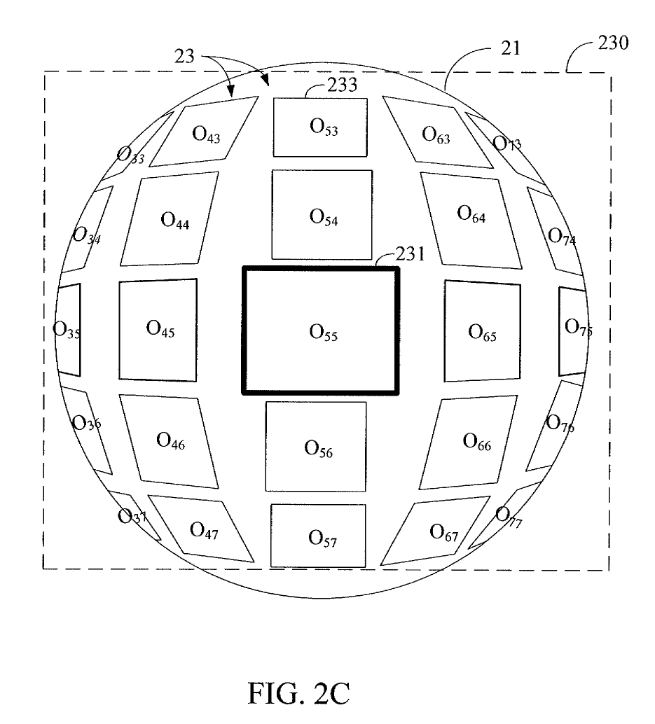

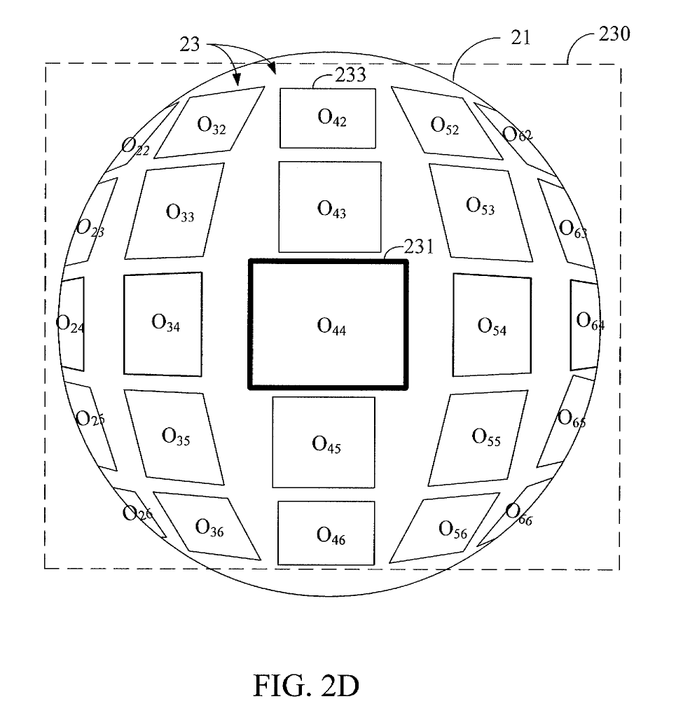

Please refer to FIG. 2A. The processor 11 of the user interface apparatus 1 is used to generate a two-dimensional menu 20 according to the setting provided by the manufacturer of the user interface apparatus 1. In this embodiment, the two-dimensional menu 20 comprises 8 column menus 22 and 8 row menus 24. That is, the two-dimensional menu 20 is an 8×8 matrix comprising 64 options. Specifically speaking, each of the column menus 22 comprises 8 sub-column options, wherein the number of the sub-column option is equal to the number of the row menus 24. Each of the row menus 24 comprises 8 sub-row options, wherein the number of the sub-row option is equal to the number of the column menus 22. From the perspective of the column, each option of the two-dimensional menu 20 is a sub-column option. From the perspective of the row, each option of the two-dimensional menu 20 is a sub-row option. In FIG. 2A, each option is denoted as Oᵢⱼ, wherein the subscript i denotes the index of columns and the subscript j denotes the index of rows. For example, the option O₂₄ means an option located at the second column and the fourth row. It can be treated as either a fourth sub-column option of the second column menu or a second sub-row option of the fourth row menu.

In this embodiment, the sub-column options comprised in each of column menus 22 have the same category. That is, each column represents a category. The categories comprise a setting, an entertainment, an internet, a phone book, a multimedia, a value-added service, a message, and an information management, etc.

In this embodiment, the category of the first column menu is “setting” whose sub-column options are: the third sub-column option of the first column menu O₁₃ being “transmission setting” function, the fourth sub-column option of the first column menu O₁₄ being “communication setting”, the fifth sub-column option of the first column menu O₁₅ being “setting”, the sixth sub-column option of the first column menu O₁₆ being “ring setting”, and the seventh sub-column option of the first column menu O₁₇ being “screen setting”.

The category of the second column menu is “entertainment” whose sub-column options are: the second sub-column option of the second column menu O₂₂ being “radio”, the third sub-column option of the second column menu O₂₃ being “standby animation”, the fourth sub-column option of the second column menu O₂₄ being “startup animation”, the fifth sub-column option of the second column menu O₂₅ being “entertainment”, the sixth sub-column option of the second column menu O₂₆ being “game”, and the seventh sub-column option of the second column menu O₂₇ being “shutdown animation”.

The category of the third column menu is “Internet” whose sub-column options are: the fourth sub-column option of the third column menu O₃₄ being “WAP (wireless application protocol) browser”, the fifth sub-column option of the third column menu O₃₅ being “Internet”, the sixth sub-column option of the third column menu O₃₆ being “E-mail”, and the seventh sub-column option of the third column menu O₃₇ being “Wi-Fi wireless network”.

The category of the fourth column menu is “phone book” whose sub-column options are: the first sub-column option of the fourth column menu O₄₁ being “call filter”, the second sub-column option of the fourth column menu O₄₂ being “call charge”, the third sub-column option of the fourth column menu O₄₃ being “dialed calls”, the fourth sub-column option of the fourth column menu O₄₄ being “received calls”, the fifth sub-column option of the fourth column menu O₄₅ being “phone book”, the sixth sub-column option of the fourth column menu O₄₆ being “phone number list”, the seventh sub-column option of the fourth column menu O₄₇ being “missed call”, and the eighth sub-column option of the fourth column menu O₄₈ being “call time”.

The category of the fifth column menu is “multimedia” whose sub-column options are: the third sub-column option of the fifth column menu O₅₃ being “play music”, the fourth sub-column option of the fifth column menu O₅₄ being “album”, the fifth sub-column option of the fifth column menu O₅₅ being “multimedia”, the sixth sub-column option of the fifth column menu O₅₆ being “camera”, and the seventh sub-column option of the fifth column menu O₅₇ being “ring edit”.

The category of the sixth column menu is “message” whose sub-column options are: the first sub-column option of the sixth column menu O₆₁ being “SMS”, the second sub-column option of the sixth column menu O₆₂ being “short message broadcasting”, the third sub-column option of the sixth column menu O₆₃ being “message setting”, the fourth sub-column option of the sixth column menu O₆₄ being “sending folder”, the fifth sub-column option of the sixth column menu O₆₅ being “message”, the sixth sub-column option of the sixth column menu O₆₆ being “receiving folder”, the seventh sub-column option of the sixth column menu O₆₇ being “message edit”, and the eighth sub-column option of the sixth column menu O₆₈ being “MMS”.

The category of the seventh column menu is “value-added service” whose sub-column options are: the fourth sub-column option of the seventh column menu O₇₄ being “stock quotation”, the fifth sub-column option of the seventh column menu O₇₅ being “value-added service”, the sixth sub-column option of the seventh column menu O₇₆ being “voice mail”, and the seventh sub-column option of the seventh column menu O₇₇ being “custom service call”.

The category of the eighth column menu is “information management” whose sub-column options are: the second sub-column option of the eighth column menu O₈₂ being “alarm”, the third sub-column option of the eighth column menu O₈₃ being “dictionary”, the fourth sub-column option of the eighth column menu O₈₄ being “calendar”, the fifth sub-column option of the eighth column menu O₈₅ being “information management”, the sixth sub-column option of the eighth column menu O₈₆ being “calculator”, and the seventh sub-column option of the eighth column menu O₈₇ being “currency conversion”.

Since the number of options for each category is different, a portion of options are empty options. The portion is reserved as an extension for future use of the mobile phone. In this embodiment, empty options comprise O₁₁, O₁₂, O₁₈, O₂₁, O₂₈, O₃₁, O₃₂, O₃₃, O₃₈, O₅₁, O₅₂, O₅₈, O₇₁, O₇₂, O₇₃, O₇₈, O₈₁, and O₈₈.

In the embodiment, each of the column menus 22 has its own individual category. In other embodiments, it can be that each of the row menus 24 has its own individual category Those killed in the art should be able to understand this easily.

A column order and a row order will be dynamically adjusted by a dynamic order adjuster 19, which uses a most recently used (MRU) method to gather the statistics of usage frequencies of column menus and sub-column options for assigning weights according to a user habit. That is, orders of the column menu in the horizontal direction and orders of the sub-column options in the vertical direction can be dynamically adjusted according to the user operation habit.

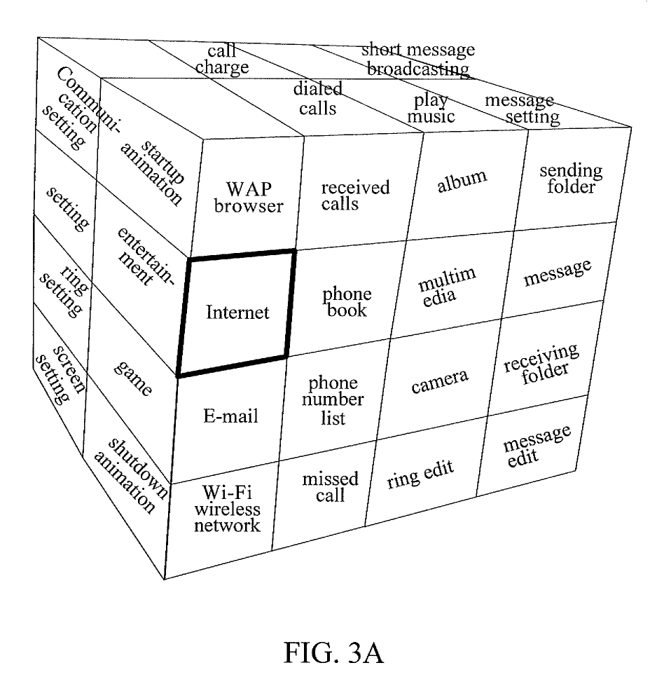

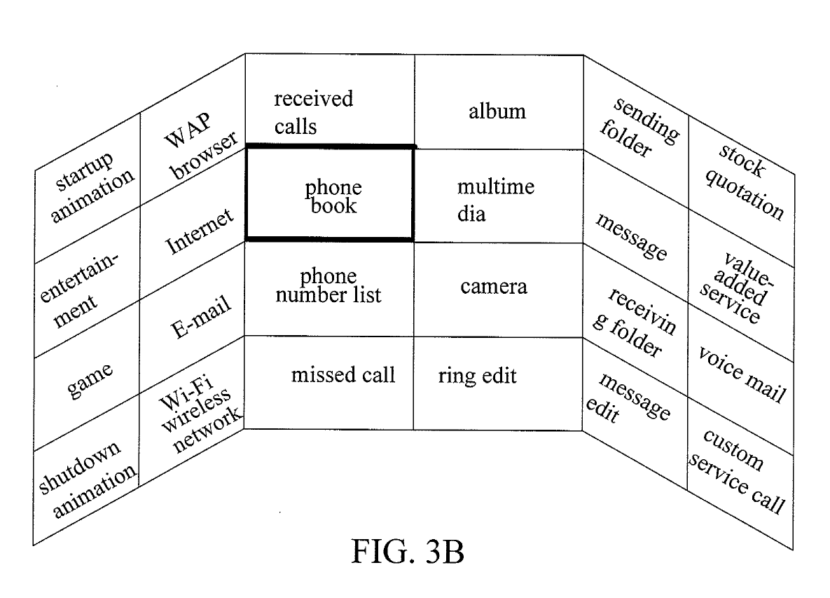

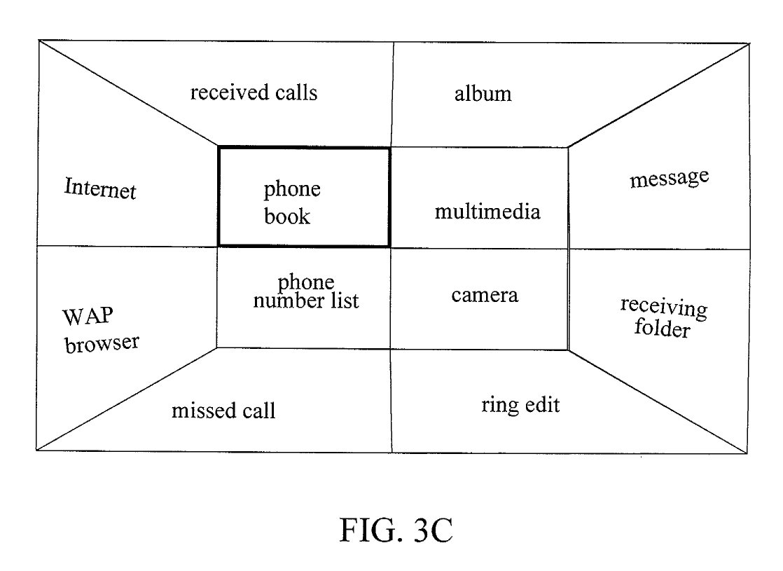

FIG. 2B shows a result of the mapping module 13 mapping at least a portion of sub-column options and at least a portion of sub-row options of the two-dimensional menu 20 to a plurality of display units 23 of a surface of a sphere 21 (i.e., a three-dimensional structure). In FIG. 2B, a plurality of rectangles 23 comprised in the surface of the sphere 21 represent the aforementioned display units 23. The rectangles not shown in this figure are those located at invisible angles of a reverse side or a lateral side. The number of the portion of sub-column options and the portion of sub-row options that correspond to the display units 23 are the number of display units. In other embodiments, the three-dimensional structure is not limited to the sphere. A cube, a cylinder, or other three-dimensional structures are also applicable. The surface of the three-dimensional structure is not limited to an outer surface, and an inner surface is also applicable. FIG. 3A, FIG. 3B, and FIG. 3C show schematic diagrams of other three-dimensional structures.

Refer back to the sphere three-dimensional structure 21 of this embodiment illustrated in FIG. 2. The outer surface of the sphere 21 comprises 8×5 display units 23, which are arranged into 8 columns comprising 5 display units respectively (it also can be explained as the these 40 display units 23 are arranged into 5 rows and each row comprises 8 display units). Each of the display units 23 is used for displaying a picture, a text, or a combination thereof for a corresponding option (each of the sub-column options and each of the sub-row options).

The screen 15 is used for displaying the mapped display units 230 of a portion of the surface of the sphere 21. The mapped display units shown on the screen 15 are defined by dotted lines and called “visible display units 230” in the following. Since the sphere 21 is three-dimensional, the two-dimensional screen 15 can only display the visible display units 230 corresponding to a portion of the surface. In this embodiment, a number of the visible display units 230 corresponding to the portion of the visible surface of the sphere 21 is 5×5=25. Furthermore, since the sphere 21 is three-dimensional, not all of the visible display units 230 are in the same size or the same shape on the screen. Display units at the boundary would be presented in a smaller area with pictures or texts of options intended for shown accompanying changes of the curved surface of the sphere 21.

The user uses a cross key as the controller 17 to select visible display units 230 of different portions of the surface of the sphere 21 for displaying. In this embodiment, the cross key is used as the controller 17 to perform two-dimensional operations, i.e. up-down and left-right. Since the sub-column options in each of the sub-column menus have the same category in this embodiment, different categories can be switched by the left-right switching and different sub-column options within the same category can be switched by the up-down switching. In other embodiments, the controller can be one of a key, a trackball, a joystick, a scroll wheel, or a screen sensor. The cross key used as the controller 17 can be further used for selecting one of required function option of the sub-column options and the sub-row options. Utilizing the cross key to move the option intended for displaying to a middle display unit 231 of the portion of the surface of the sphere 21, the screen 15 will enlarge and circle the option mapped to the middle display unit 231 at this time. The user can select this option by pressing a central of the cross key.

While selecting the visible display units 230 of different portions of the surface of the sphere 21, for example, switching from the category of the column menu of the option that is mapped to the middle display unit 231, (i.e. O₄₅, “phone book”) to the category of the column menu right adjacent to the middle display unit 231 (i.e. O₅₅, “multimedia”), the user presses the right button of the cross key to move one unit to the right, which is treated as rotating one unit to the left of the sphere 21. The display of the screen 15 shows the display result of FIG. 2C from FIG. 2B so that another portion of the visible display units 23 of the surface of the sphere 21 can be shown on the screen 15. At this time, an order calculation for the column menus displayed on the right boundary is shown as follows.

Let the number of column menus of the two-dimensional menu 20 be m, the column menu order of the right boundary be c, the number of column menus capable of being displayed by the display unit each time be p, the column menu order of the current option circled by the controller 17 be x. By using an equation of c=x+((p−1)/2+1), a value for c can be derived, wherein if the derived c is greater than m, the derived value is yet required to subtract m. In this embodiment, the number of the column menus m is 8, the number of column menus capable of being displayed by the display unit each time p is 5, the column menu order of the current option circled by the controller 17 is the fourth column menu as shown in FIG. 2B. After moving one unit to the right, the column menu order displayed at the right boundary is 7. That is, after moving one unit to the right, the right boundary displays the seventh menu as shown in FIG. 2C. If the calculation for the column menu order displayed at the left boundary is intended, the aforementioned equation can be changed to c=x−((p−1)/2+1).

In other embodiments, if a total number of options is less than or equal to the number of the display units, all options can be mapped to the display unit 23. That is, the mapping module 13 can map all the sub-column options and all the sub-row options to the display units 23. However, since the number of display units of the surface of the sphere 21 in this embodiment is smaller than the total number of options (40 is less than 56), there are 24 options of the first sub-column option, the second sub-column option and the eighth sub-column option of each of the column menu 22 can not be mapped to the display units 23 temporarily When using the controller 17 to select the visible display units 230 of different portions on the surface of the sphere 21 to be displayed, for example, pressing the up key of the cross key by the user to move one unit upward, which can be treated as the sphere 21 rotating one unit downward, the fifth sub-column option of the fourth column menu O₄₅ with a main function of “phone book” comprised in the option of the middle display unit 231 moves one unit downward. Options of the unmapped portion are able to be remapped to the display unit so that another portion of visible display units 230 of the surface of the sphere 21 can be displayed on the screen 15 as shown in FIG. 2D. Meanwhile, an order calculation for the sub-column options displayed on the upper boundary is shown as follows.

Let the number of sub-column options of the two-dimensional menu 20 be n, the sub-column options order of the up boundary be d, the number of sub-column options capable of being displayed by the display unit each time be q, the sub-column options order of the current option circled by the controller 17 be y, and then calculate d=y−((q−1)/2+1). If the derived d is greater than n, the derived value is yet required to subtract n. In this embodiment, the number of the sub-column options n is 8, the number of sub-column options capable of being displayed by the display unit each time q is 5, the sub-column options order of the current option circled by the controller 17 is the fifth sub-column options. After moving one unit upward, the sub-column options order displayed at the upper boundary is 2. That is, after moving one unit upward, the upper boundary displays the second sub-column option. The second sub-column option of the fourth column menu O₄₂, which is originally unmapped to the display unit, is remapped to the upper-middle display unit 233. Consequently, by using the cross key, the portion mapped to the display unit 23 in the two-dimensional menu 20 can be controlled, and the unmapped options would be mapped to the display unit 23 for displaying. If the calculation for the sub-column option order displayed at the lower boundary is intended, the aforementioned equation can be changed to d=y+((q−1)/2+1).

To be emphasized is that the invention can also be used to other user interface apparatuses without the three-dimensional menu by adding the processor 11 and the mapping module 13 (the dynamic order adjuster 19 can be added optionally) to their original architectures. The processor will spread the hierarchical menus of the original user interface apparatus to generate the two-dimensional menu 20. The mapping module will map the generated two-dimensional menu 20 of the spread hierarchical menus to the display unit 23 of the polyhedron surface of the three-dimensional space architecture. Later, the portion of display units will be displayed by the existing screen 15 of the original user interface apparatus.

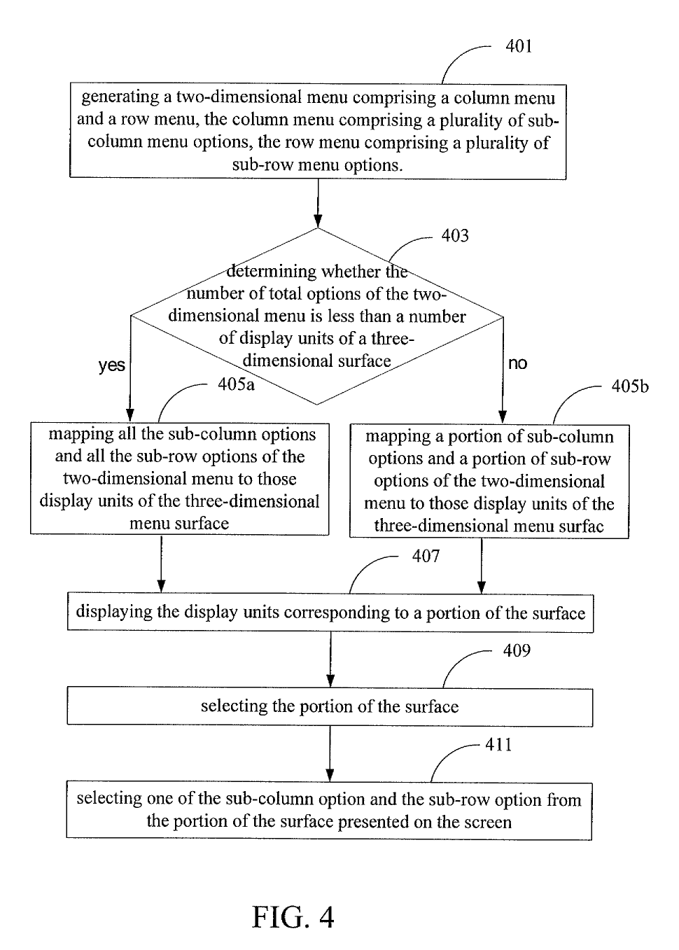

A second embodiment of the second embodiment of the invention is shown in FIG. 4 which is a user interface processing method. The embodiment is used in a mobile phone. In other embodiments, the method of the invention can be applied to other apparatuses using a screen for displaying a menu, such as a PDA, a PMP, a computer, etc. The invention is especially suitable for handheld apparatuses to provide more information for users.

At first, the second embodiment executes step 401 for generating a two-dimensional menu comprising a column menu and a row menu. The column menu comprises a plurality of sub-column menu options, and the row menu comprises a plurality of sub-row menu options. These sub-column options and the sub-row options are called options for the two-dimensional menu. Specifically speaking, the number of the sub-column options is equal to the number of the row menus, and the number of the sub-row options is equal to the number of the row menus. Each option is presented by a picture, a text, or a combination thereof. In this embodiment, the sub-column options of the same column menu have the same category which can be one of a setting, a phone book, an entertainment, a multimedia, an Internet, a value-added service, a message, and an information management. In other embodiment, the sub-row option of the same row menu can be set to comprise the same category.

Next, step 403 is executed for determining whether the number of total options of the two-dimensional menu is smaller than a number of display units of a three-dimensional surface. Later, according to the determination result of step 403, step 405(a) or step 405(b) can be executed. If yes in step 403, step 405(a) is executed for mapping all the sub-column options and all the sub-row options of the two-dimensional menu to those display units of the three-dimensional menu surface. If no in step 403, step 405(b) is executed for mapping a portion of sub-column options and a portion of sub-row options of the two-dimensional menu to those display units of the three-dimensional menu surface. The three-dimensional structure can be a sphere, a cube, a cylinder, or other three-dimensional space structures and the surface can be either an outer surface or an inner surface of the aforementioned three-dimensional structure.

After executing step either 405(a) or step 405(b), step 407 is executed for displaying the display units corresponding to a portion of the surface. Since the three-dimensional structure is three-dimensional, the two-dimensional screen only shows the display units corresponding to the portion of the surface. Furthermore, since the three-dimensional structure is three-dimensional, not all the options displayed by each display unit are presented with the same area or the same shape. Display units at the boundary will follow changes of the three-dimensional structure to shrink the area and to twist the shape with pictures or texts of options intended for shown.

Step 409 is executed for selecting the portion of the surface. For a more detailed description, if not all the display units of the three-dimensional structure are presented on the screen, a controller can be used for selecting other portions of the three-dimensional structure to display on the screen. Finally, step 411 is executed for selecting one of the sub-column option and the sub-row option from the portion of the surface presented on the screen.

In addition to the steps shown in FIG. 4, the second embodiment can execute all operations or functions described in the first embodiment. People who are ordinary skilled in the art can directly understand how the second embodiment can execute the operations and functions based on the aforementioned first embodiment. Consequently, descriptions for the operations and functions are redundant and are not repeated herein.

A third embodiment of the invention is another user interface processing method used in a user interface apparatus. The method is applied to the user interface 1 of the first embodiment.

At first, step 501 is executed for making the processor 11 generate a two-dimensional menu 20, which comprises a column menu 22 and a row menu 24. The column menu 22 comprises a plurality of sub-column options and the row menu 24 comprises a plurality of sub-row options. Next, step 503 is executed for making the mapping module 13 map the sub-column options and the sub-row options of the two-dimensional menu 20 to the plurality of display units 23 of a surface of the three-dimensional structure 21. In step 505, let the screen 15 display the visible display units 220 corresponding to a portion of the surface. In step 507, let the controller 16 select a portion of the surface. For a more detailed description, if not all the display units of the three-dimensional structure are presented on the screen, the controller selects other portions of the three-dimensional structure. In step 509, the controller 17 selects one of the sub-column options and the sub-row options.

In addition to the aforementioned steps, the third embodiment can execute all operations or functions described in the first embodiment. People who are ordinary skilled in the art can directly understand how the third embodiment can execute the operations and functions based on the aforementioned first embodiment. Consequently, descriptions for the operations and functions are redundant and are not repeated herein.

The aforementioned methods can be realized by an application program. That is, resource assignment apparatuses are installed by the appropriate application programs to execute the aforementioned methods. The application programs can be stored in a computer readable medium. The computer readable medium can be a floppy disk, a hard disk, an optical disc, a flash disk, a tape, a database accessible from a network, or a storage medium with the same functionality that can be easily thought by people skilled in the art.

The invention enables the screen to show more information so that browsed information each time for the user is increased and current browsing conditions, functions of the present reading column menu, available sub-column options, and even options of other column menus are know to the user. To be more specific, the invention makes the options shown on the screen not limited to only one category. Consequently, when the user does not know the category for some options, the user can find out the location of the option quickly for further selections and operations. Furthermore, the dynamic order adjuster of the invention makes the most frequently used options to appear at nearest started locations of the menu according to personal usage habit to enhance the operation efficiency of the user. Consequently, the user interface apparatus utilizing the invention can achieve an objective of easy browsing and convenient operating. Users can learn and operate the user interface in an easy, simple, high efficiency, and not time consuming way. Thus, it indeed meets market requirements of this field.

The above disclosure is related to the detailed technical contents and inventive features thereof. People skilled in this field may proceed with a variety of modifications and replacements based on the disclosures and suggestions of the invention as described without departing from the characteristics thereof. Nevertheless, although such modifications and replacements are not fully disclosed in the above descriptions, they have substantially been covered in the following claims as appended.

What is claimed is:

1. A user interface apparatus, comprising:
a processor for generating a two-dimensional menu, the two-dimensional menu comprising a column menu and a row menu, the column menu comprising a plurality of sub-column options, the row menu comprising a plurality of sub-row options;
a mapping module for mapping a portion of the sub-column options and a portion of the sub-row options of the two-dimensional menu to a plurality of display units of a surface of a three-dimensional structure; and
a screen for displaying the display units corresponding to a portion of the surface.

2. The user interface apparatus as claimed in claim 1, wherein the mapping module further maps all of the sub-column options and all of the sub-row options to the display units.

3. The user interface apparatus as claimed in claim 1, further comprising a controller for selecting one of the sub-column options and the sub-row options.

4. The user interface apparatus as claimed in claim 1, further comprising a controller for selecting the portion of the surface.

5. The user interface apparatus as claimed in claim 3, wherein the controller is one of a key, a trackball, a joystick, and a screen sensor.

6. The user interface apparatus as claimed in claim 4, wherein the controller is one of a key, a trackball, a joystick, and a screen sensor.

7. The user interface apparatus as claimed in claim 1, wherein either the sub-column options or the sub-row options belong to a same category.

8. The user interface apparatus as claimed in claim 1, further comprising a dynamic sequence adjustor for dynamically adjusting a column sequence of each of the sub-column options and a row sequence of each of the sub-row options.

9. A user interface processing method, comprising:
generating a two-dimensional menu, the two-dimensional menu comprising a column menu and a row menu, the column menu comprising a plurality of sub-column options, the row menu comprising a plurality of sub-row options;
mapping a portion of the sub-column options and a portion of the sub-row options of the two-dimensional menu to a plurality of display units of a surface of a three-dimensional structure; and
displaying the display units corresponding to a portion of the surface.

10. The user interface processing method as claimed in claim 9, wherein the mapping step comprises a step of mapping all of the sub-column options and all of the sub-row options to the display units.

11. The user interface processing method as claimed in claim 9, further comprising a step of selecting one of the sub-column options and the sub-row options.

12. The user interface processing method as claimed in claim 9, further comprising a step of selecting the portion of the surface.

13. The user interface processing method as claimed in claim 9, wherein either the sub-column options or the sub-row options belong to a same category.

14. The user interface processing method as claimed in claim 9, further comprising a step of adjusting a column sequence of each of the sub-column options and a row sequence of each of the sub-row options dynamically.

15. A computer readable medium for storing an application program, the application program controlling the user interface apparatus to execute a user interface processing method, the user interface processing method comprising the following steps of:
generating a two-dimensional menu, the two-dimensional menu comprising a column menu and a row menu, the column menu comprising a plurality of sub-column options, the row menu comprising a plurality of sub-row options;
mapping a portion of the sub-column options and a portion of the sub-row options of the two-dimensional menu to a plurality of display units of a surface of a three-dimensional structure; and
displaying the display units corresponding to a portion of the surface.

16. The computer readable medium as claimed in claim 15, wherein the mapping step comprises a step of mapping all of the sub-column options and all of the sub-row options to the display units.

17. The computer readable medium as claimed in claim 15, wherein the user interface processing method further comprises a step of selecting one of the sub-column options and the sub-row options.

18. The computer readable medium as claimed in claim 15, wherein the user interface processing method further comprises a step of selecting the portion of the surface.

19. The computer readable medium as claimed in claim 15, wherein either the sub-column options or the sub-row options belong to a same category.

20. The computer readable medium as claimed in claim 15, wherein the user interface processing method further comprises a step of adjusting a column sequence of each of the sub-column options and a row sequence of each of the sub-row options dynamically.
